(19) United States
(12) Patent Application Publication
(10) Pub. No.: US 2016/0063197 A1
(43) Pub. Date: Mar. 3, 2016

(54) User Interactive Electronic Health Records Management System for Processing Workers Compensation Transactions

(71) Applicant: Fred J. Kumetz, Beverly Hills, CA (US)

(72) Inventor: Fred J. Kumetz, Beverly Hills, CA (US)

(21) Appl. No.: 14/475,679

(22) Filed: Sep. 3, 2014

(51) Int. Cl. G06F 19/00; G06Q 10/10

(52) U.S. Cl. CPC G06F 19/328; G06F 19/322; G06Q 10/1057

(57) ABSTRACT

Provided herein are systems and methods for creating, obtaining and updating healthcare records and workers' compensation information for a patient. The system for creating a healthcare record for one or more medical event(s) of the patient has a computer having at least a processor, a memory and a display coupled to the processor and at least one network connection and a user interactive tool coupled to the computer with a plurality of modules configured to process worker's compensation information and a plurality of databases related to healthcare information of the patient accessible by the modules. The methods utilize the interactive tool to receive, store and categorize health information and create and update a healthcare record therefrom and further to search and retrieve user-selected medical event information from the databases. Also provided are non-transitory machine-readable storage mediums comprising processor executable instructions for performing the described methods.

### BACKGROUND OF THE INVENTION

1. Field of the Invention

The present invention relates generally to the fields of healthcare information providing system and workers' compensation transactions. More specifically, the present invention relates to healthcare computing systems, platforms, models and methods related to healthcare records of patients to manage workers' compensation claims.

2. Description of the Related Art

Workers' compensation is a class of insurance mandated by States and the federal government whereby employers provide employees with medical and disability benefits for injuries or illness incurred in the course and scope of their employment. When the work-related injury or illness occurs, the employer reports the occurrence to the payer (insurer, self-insurer, or third-party administrator), who then creates a claim file, assigns a claim number and handles the compensation related matters. Traditional electronic health record systems are meant for the positions to track the medical treatment and medical information of patients and the access to the information is restricted to the individuals at the healthcare provider facility where the patient receiving the treatment for one or more conditions. As a result, insurers and employers find it difficult to obtain medical treatment records pertinent to workers' compensation claims causing signification delay in completing the payment transactions. Therefore, it is desired to produce an improved Workers' Compensation information processing system where the insurers and employers have access to certain electronic health records.

Thus, the present disclosure provides Workers' Compensation information processing system that provides electronic health records of patients to insurers and employers. Specifically, the present disclosure provides healthcare computing systems, platforms, models and methods to provide access to electronic health records of patients within the HIPPA regulations.

### SUMMARY OF THE INVENTION

The present invention is directed to a system for creating a healthcare record for one or more medical event(s) of a patient. The system comprises a computer having at least a processor, a memory, a display coupled to the processor, at least one network connection and a user interactive tool coupled to the computer. The user interactive tool comprises a plurality of modules configured to process worker's compensation information and a plurality of databases related to healthcare information of the patient accessible by the modules. The present invention is directed to a related system where the user interactive tool is further configured to enable instructions to update the healthcare record of the patient.

The present invention also is directed to a user-customized method for obtaining a healthcare record for one or more medical event(s) of a patient. The method comprises the steps of accessing the user interactive tool comprising the system of the present invention and inputting a query by a user about user-selected medical events of the patient. The one or more modules comprising the user-interactive tool searches the databases for the user-selected medical events and retrieves a healthcare record comprising the information about the user-selected medical events from the databases. The healthcare record is transmitted to the user. The present invention is directed to a related method further comprising updating the healthcare record via the modules. The present invention is directed to another related method further comprising assigning a case number to injury date data in a worker's compensation claim of the patient.

The present invention is directed further to a method for providing patient information related to a worker's compensation transaction. The method comprises receiving a user inquiry as input into a healthcare computing system comprising at least one computer having a memory, a processor and at least one network connection, processing the inquiry with an application or components thereof distributed and deployed to a local server on the healthcare computing system and displaying a response to the inquiry.

The present invention is directed further still to a non-transitory machine-readable storage medium comprising processor executable instructions for performing the methods described herein.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1 is a general flow chart of typical worker's compensation process.

FIG. 2A is a block diagram illustrating an exemplary Electronic Health Record (EHR) of present invention.

FIG. 2B is a block diagram illustrating the Home (114) module of FIG. 2A.

FIG. 2C is a block diagram illustrating the Scheduler (116) module of FIG. 2A.

FIG. 2D is a block diagram illustrating the Charts (118) module of FIG. 2A.

FIG. 2E is a block diagram illustrating the Patient Charts (172) feature of FIG. 2D.

FIG. 2F is a block diagram illustrating the Appointment Tracker (174) feature of FIG. 2D.

FIG. 2G is a block diagram illustrating the Check-in (176) feature of FIG. 2D.

FIG. 2H is a block diagram illustrating the Intake (186) feature of FIG. 2D.

FIG. 2I is a block diagram illustrating the Exam (188) feature of FIG. 2D.

FIG. 2J is a block diagram illustrating the Sign-Off (190) feature of FIG. 2D.

FIG. 2K is a block diagram illustrating the Check-Out (180) feature of FIG. 2D.

FIG. 2L is a block diagram illustrating the Messages (138) module of FIG. 2A.

FIG. 2M is a block diagram illustrating the Documents (122) module of FIG. 2A.

FIG. 2N is a block diagram illustrating the Documents Type (314) feature of FIG. 2M.

FIG. 2O is a block diagram illustrating the Billing (124) module of FIG. 2A.

FIG. 2P is a block diagram illustrating the Reports (126) module of FIG. 2A.

FIG. 2Q is a block diagram illustrating the Clinical Report (368) feature of FIG. 2P.

FIG. 2R is a block diagram illustrating the Settings (128) module of FIG. 2A.

FIG. 2S is a block diagram illustrating the Template (424) feature of FIG. 2R.

FIG. 2T is a block diagram illustrating the Quickpick (426) feature of FIG. 2R.

FIG. 3 is a flowchart illustrating the process of inquiring healthcare records by the user using injury date data.

### DETAILED DESCRIPTION OF THE INVENTION

As used herein, the term “a” or “an” when used in conjunction with the term “comprising” in the claims and/or the specification may mean “one,” but it is also consistent with the meaning of “one or more,” “at least one,” and “one or more than one.” Some embodiments of the invention may consist of or consist essentially of one or more elements, method steps, and/or methods of the invention. It is contemplated that any method described herein can be implemented with respect to any other method described herein.

As used herein, the term “or” in the claims is used to mean “and/or” unless explicitly indicated to refer to alternatives only or the alternatives are mutually exclusive, although the disclosure supports a definition that refers to only alternatives and “and/or.”

As used herein, the term “computer” generally includes: a processor, a memory, at least one information storage/retrieval apparatus such as, for example, a hard drive, a disk drive or a flash drive or memory stick, or other non-transitory computer readable media or non-transitory storage device, as is known in the art, at least one input apparatus such as, for example, a keyboard, a mouse, a point and touch device, a touch screen, or a microphone; and a display structure, such as the well-known computer screen. Additionally, the computer may include one or more network connections, such as wired or wireless connections. Such a computer or computer system may include more or less than what is listed above and encompasses other electronic media or electronic devices, as is known in the art, for example, but not limited to tablet computers or smart devices.

In one embodiment of present invention, there is provided a system for creating a healthcare record for one or more medical event(s) of a patient comprising a computer having at least a processor, a memory and a display coupled to the processor and at least one network connection and a user interactive tool coupled to the computer comprising a plurality of modules configured to process worker's compensation information; and a plurality of databases related to healthcare information of the patient accessible by the modules. Further to this embodiment the user interactive tool is configured to update the healthcare record of the patient.

In a preferred aspect of both embodiments, the healthcare information of the patient comprises injury date data and disability status of the patient. The healthcare information of the patient also comprises a case number assigned to the injury date data of the patient. In another preferred aspect of both embodiments, the healthcare information comprises medical event(s) categorized by injury date data of the patient and the treatment data of the patient's condition, injury or disease. The healthcare information of the patient comprises worker's compensation transactions. In a non-limiting example, the user may be an employer, an attorney, a physician or other medical provider, or an insurance company.

In a preferred aspect of both embodiments, the user interactive tool modules are configured to a) receive information related to one or more medical event(s) of interest of said patient; b) store and categorize the medical event(s) of the patient and information related thereto in a raw information library comprising the databases; and c) create the healthcare record comprising the healthcare information of the patient. Further to this preferred aspect the user interactive tool modules are configured to update the healthcare record of the patient via iteration of a) to c).

In a further preferred aspect of both embodiments, the user interactive tool modules are configured to d) receive as input a query about user-selected medical events; e) search one or more databases about the user-selected medical event(s) information; f) retrieve the user-selected medical event(s) information from the databases; g) update the retrieved user-selected medical event(s) in the health record of the patient; and h) transmit the modified health record to the user. Further to this preferred aspect the user interactive tool modules are configured to reiterate steps d) to h) upon input of an additional query.

In another embodiment of present invention, there is provided a user-customized method for obtaining a healthcare record of one or more medical event(s) of a patient, comprising the steps of accessing the user interactive tool comprising the system as described herein; user-inputting a query about user-selected medical events of said patient; searching the databases for the user-selected medical events via the one or more modules comprising the user interactive tool; retrieving a healthcare record comprising information about the user-selected medical events from the databases; and transmitting the healthcare record to the user. Further to this embodiment the method comprises updating the healthcare record via the modules.

In a preferred aspect of this embodiment, the healthcare record comprises information on worker's compensation claims of the patients. Further to this aspect the method comprises assigning a case number to injury date data in the worker's compensation claim. In all embodiments and aspects the healthcare record comprises disability status of said patient. Also, the healthcare record comprises treatment data of the patient's condition, injury or disease.

In an aspect of this embodiment, there is a non-transitory machine-readable storage medium comprising processor executable instructions for performing the method of the invention disclosed herein.

In yet another embodiment of present invention, there is provided a method for providing patient information related to a worker's compensation transaction to a user, comprising the steps of a) receiving a user inquiry as input into a healthcare computing system comprising at least one computer having a memory, a processor and at least one network connection; b) processing the inquiry with an application or components thereof distributed and deployed to a local server on the healthcare computing system; and c) displaying a response to the inquiry to the user. In a preferred aspect of this embodiment, the worker's compensation transaction comprises injury date data, treatment data and disability status data of said patient.

In yet another embodiment of the present invention, there is provided a non-transitory storage medium having tangibly stored thereon instructions that, when executed by at least one processor of an electronic device, cause the electronic device to perform the methods of the invention disclosed herein.

In a related embodiment of the present invention, there is provided a non-transitory computer readable medium comprising software for creating a healthcare record for one or more medical event(s) of a patient, which when executed using at least one computer having at least a memory, a processor and a network connection, is configured to enable instructions to a) receive information related to one or more medical event(s) of interest of said patient; b) store and categorize the medical event(s) of the patient and information related thereto in a raw information library; and c) create healthcare record comprising the healthcare information of said patient. Further to this embodiment, the non-transitory computer readable medium is configured to enable instructions to update the healthcare record of the patient via iteration of steps a to c as described supra.

In another further related embodiment, the computer readable medium is configured to enable instructions to: d) receive as input a query about user-selected medical events; e) search one or more databases about the user-selected medical event(s) information; f) retrieve the user-selected medical event(s) information from the databases; g) update the retrieved user-selected medical event(s) in the healthcare record of said patient; and h) transmit the modified healthcare record to the user. Further still, the non-transitory computer readable medium is configured to enable instructions to reiterate steps d to h upon input of an additional query.

In an embodiment of the present invention there is provided a computer program product, tangibly embodied in the non-transitory computer readable medium of present invention.

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

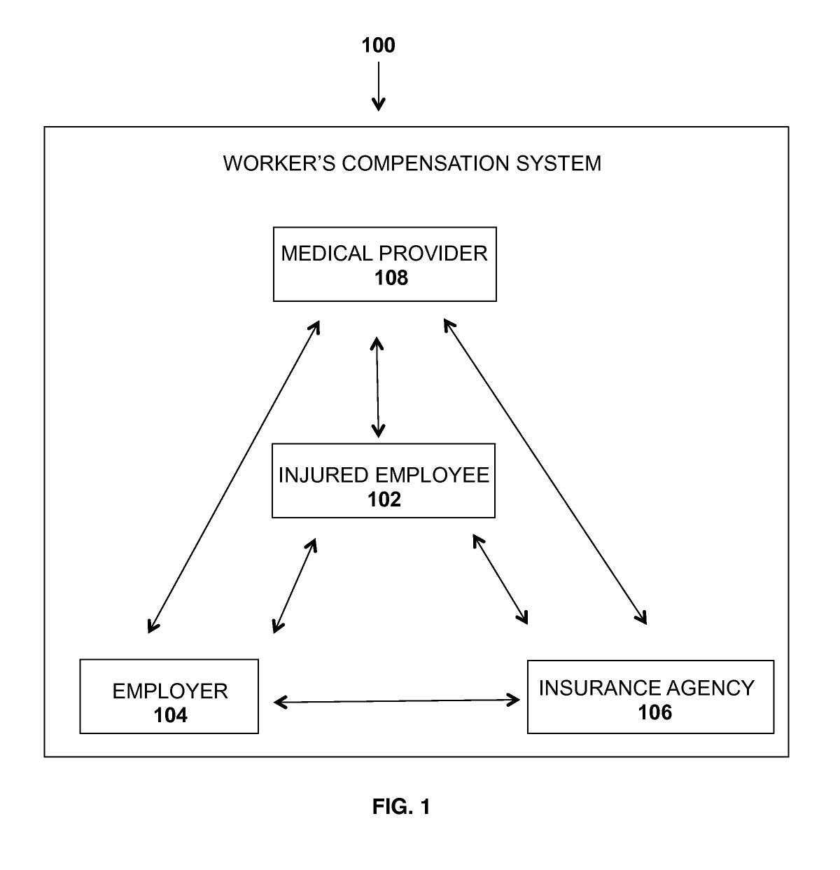

With reference to the figures, FIG. 1 is a depiction of the workers' compensation process. The key parties to the workers' compensation process 100 include the injured employee 102, the employer 104, the insurance agency 106 and the medical provider 108. As depicted in FIG. 1, many parties interact in the workers' compensation process and often the action of the parties takes place in a defined sequence. In order to file a worker's compensation claim, an employer 104 submits a worker's compensation claim to a worker's compensation carrier 106 that is providing worker's compensation insurance coverage. The carrier will determine how much the employee may get paid for their injuries and related problems. These payments are determined using pre-defined schedules set by statute or other governmental regulations.

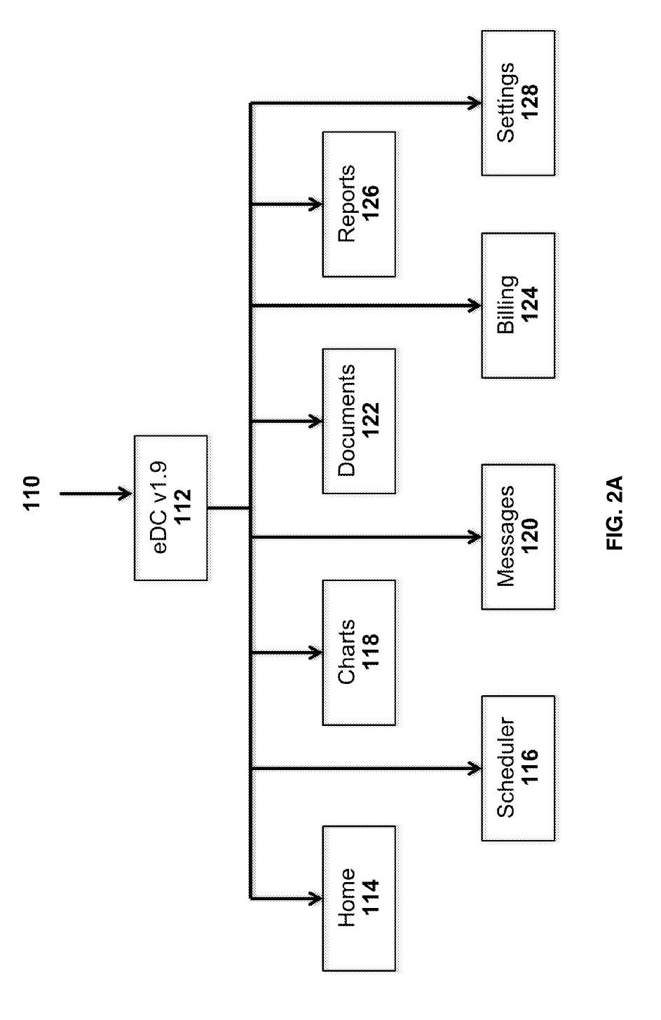

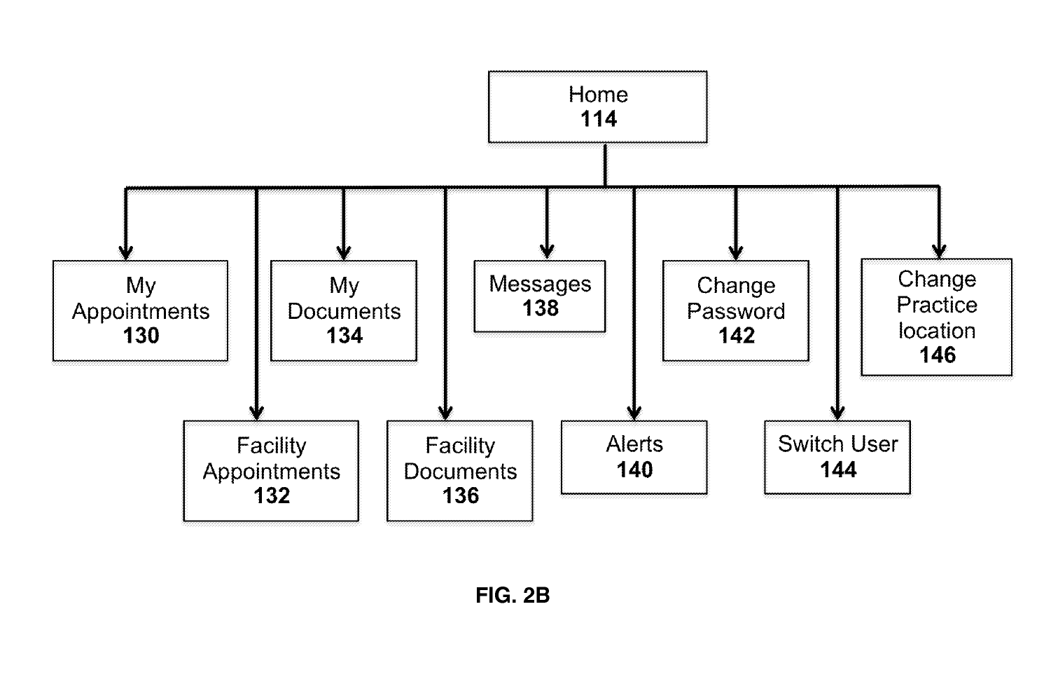

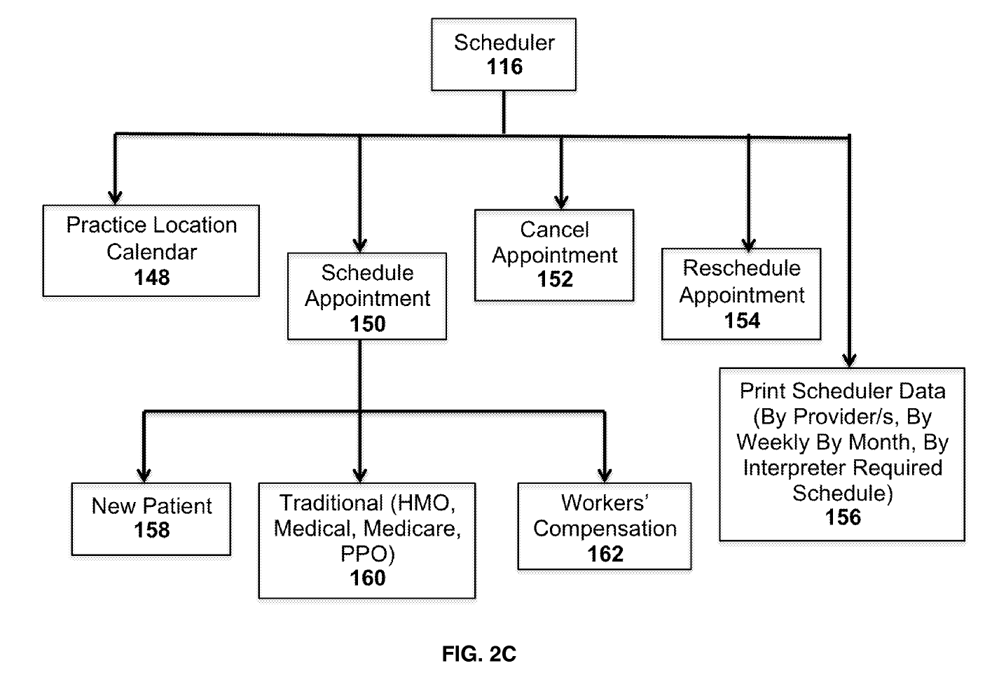

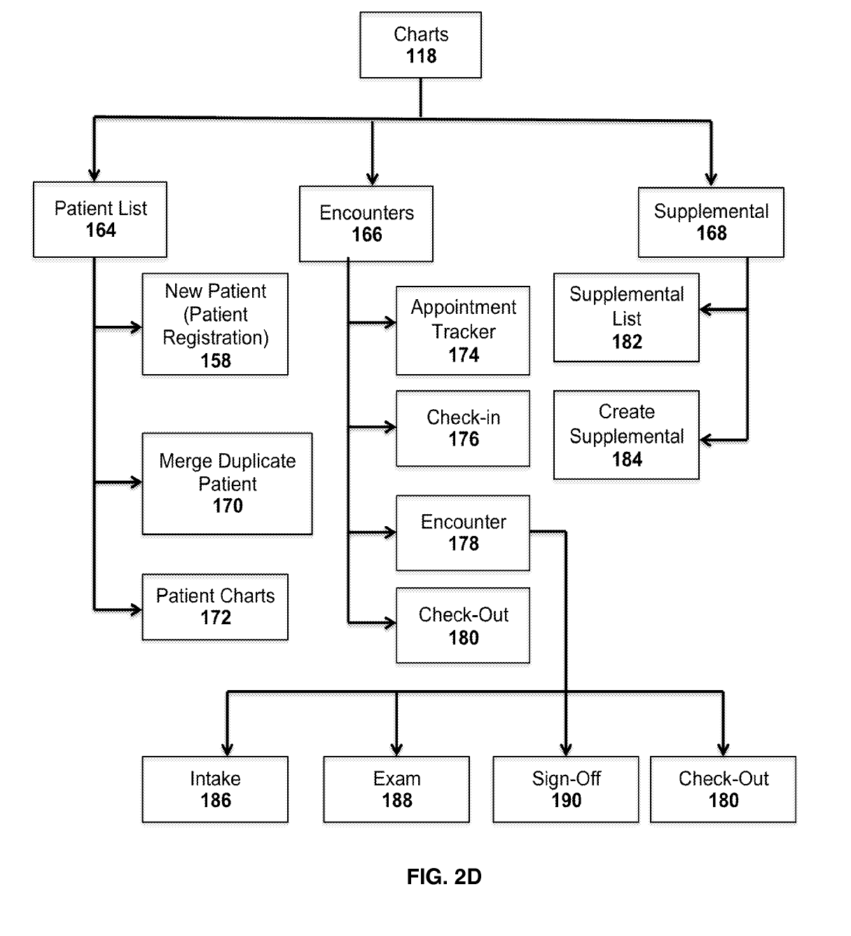

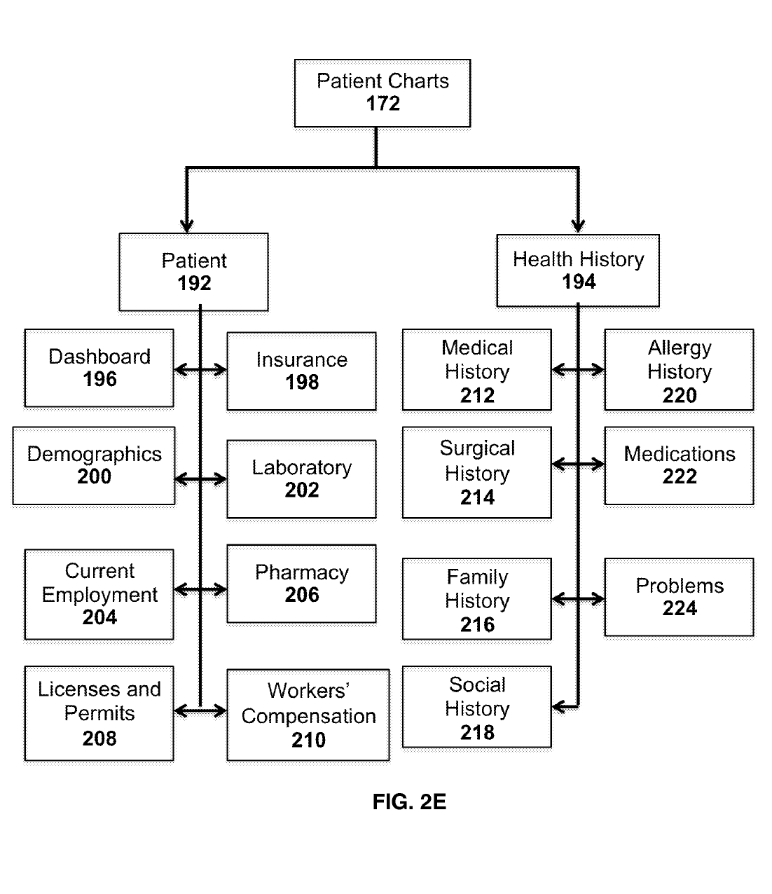

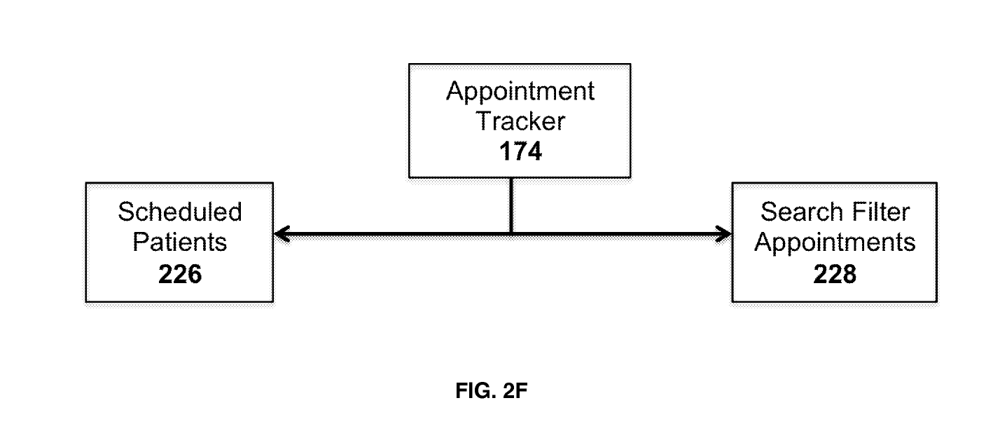

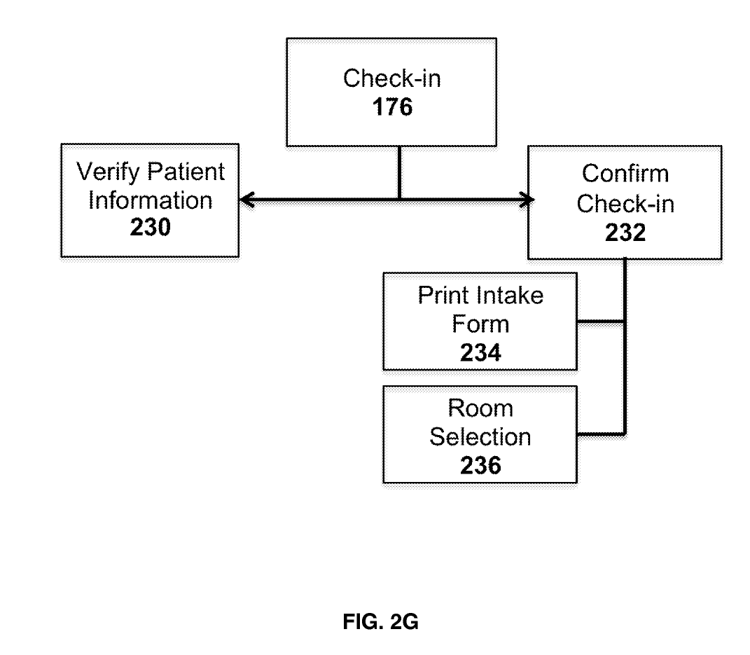

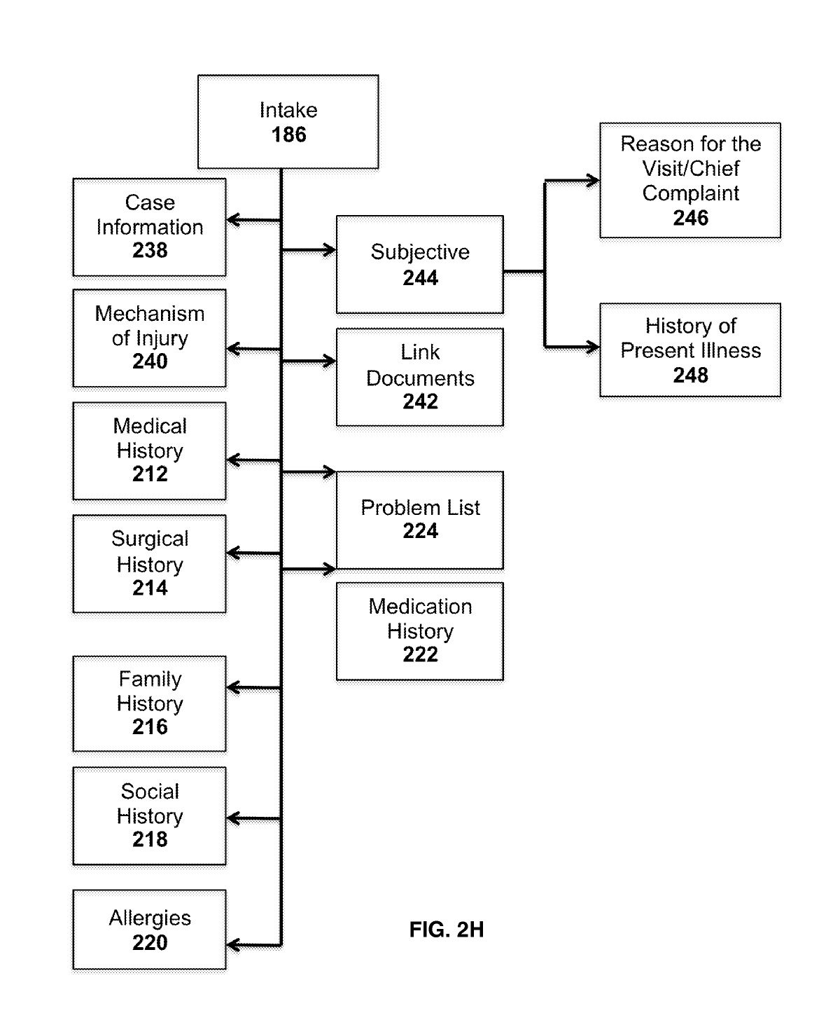

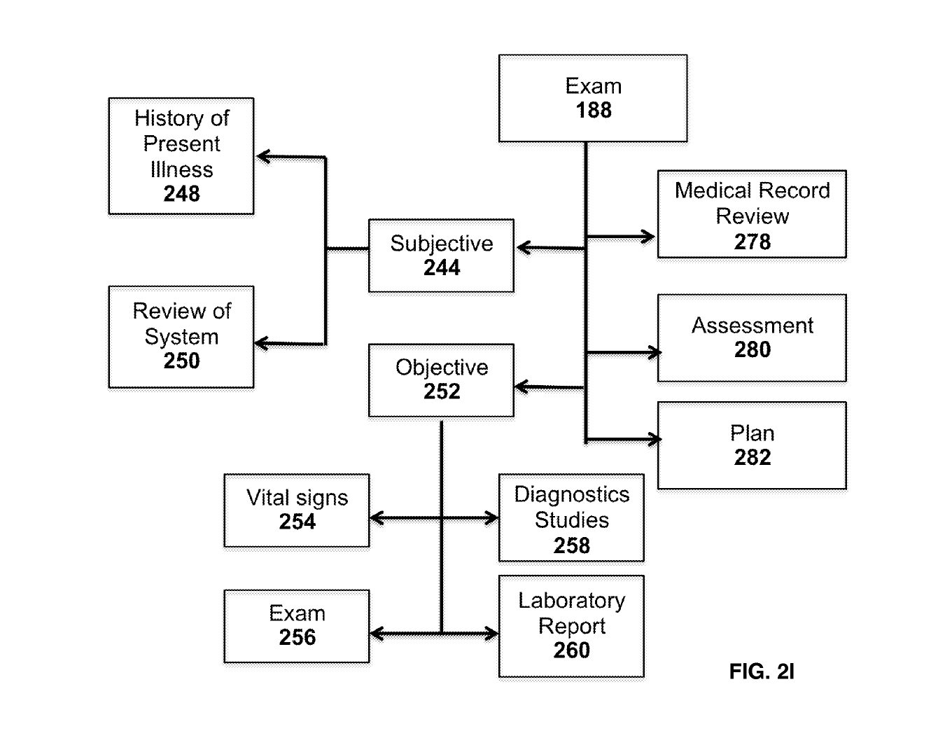

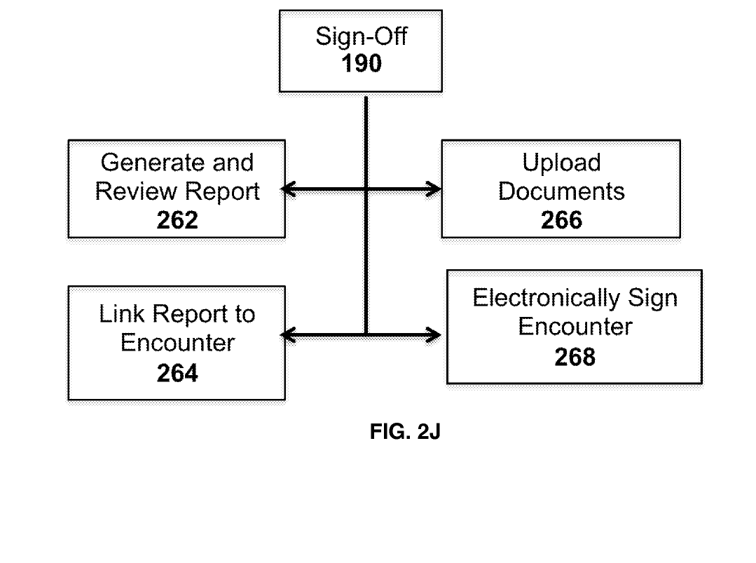

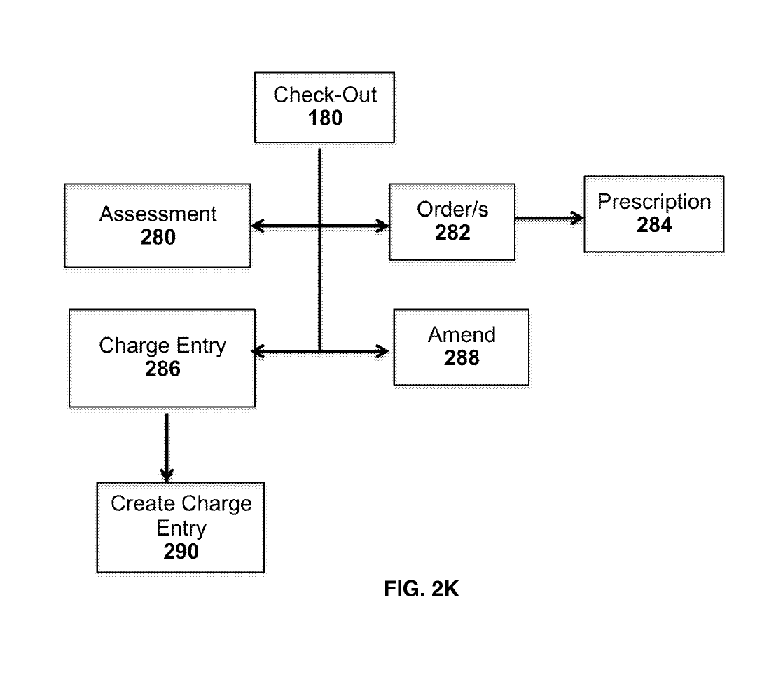

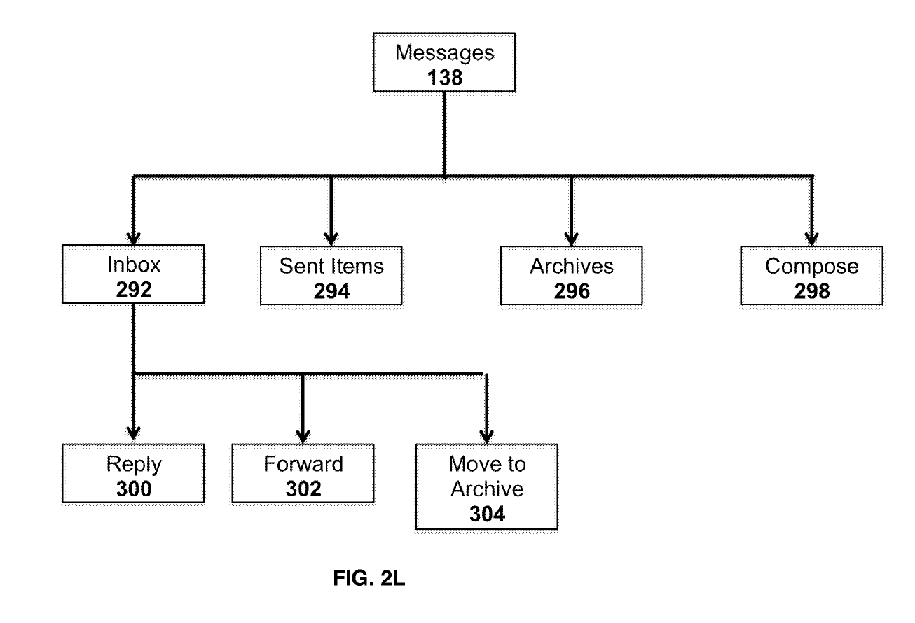

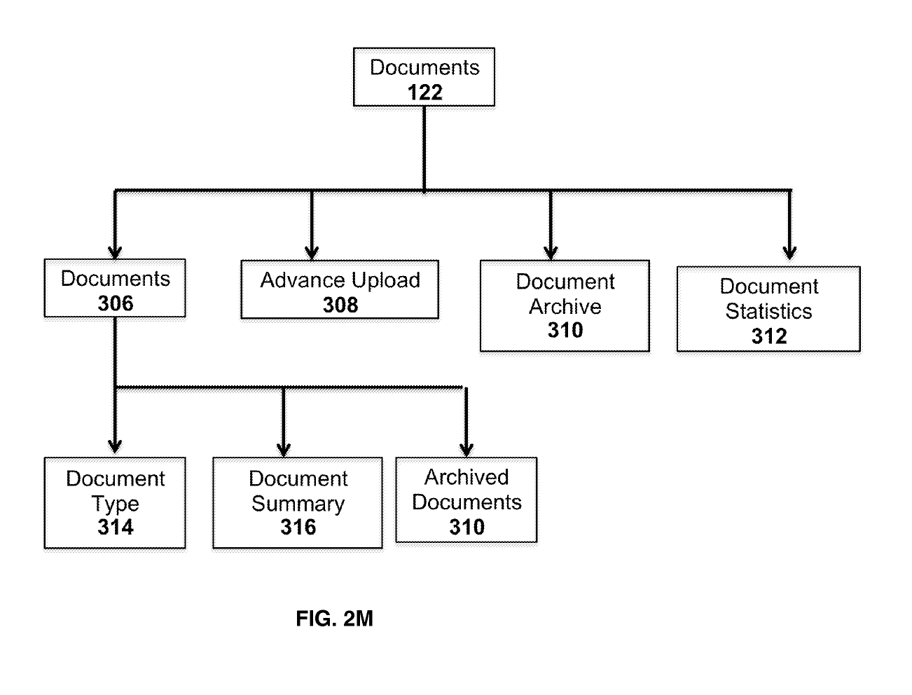

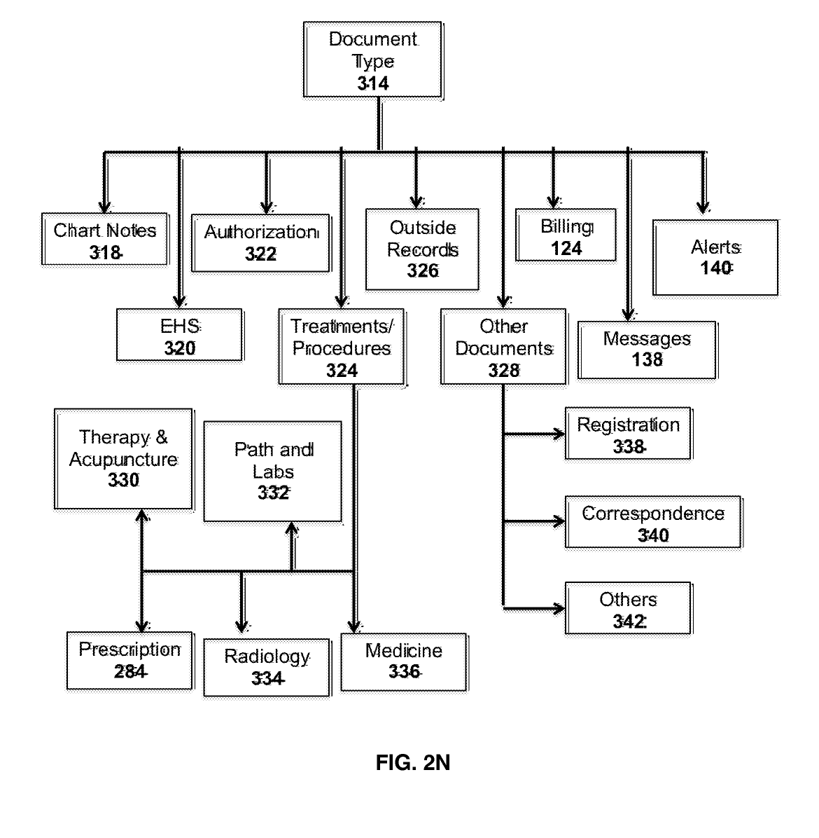

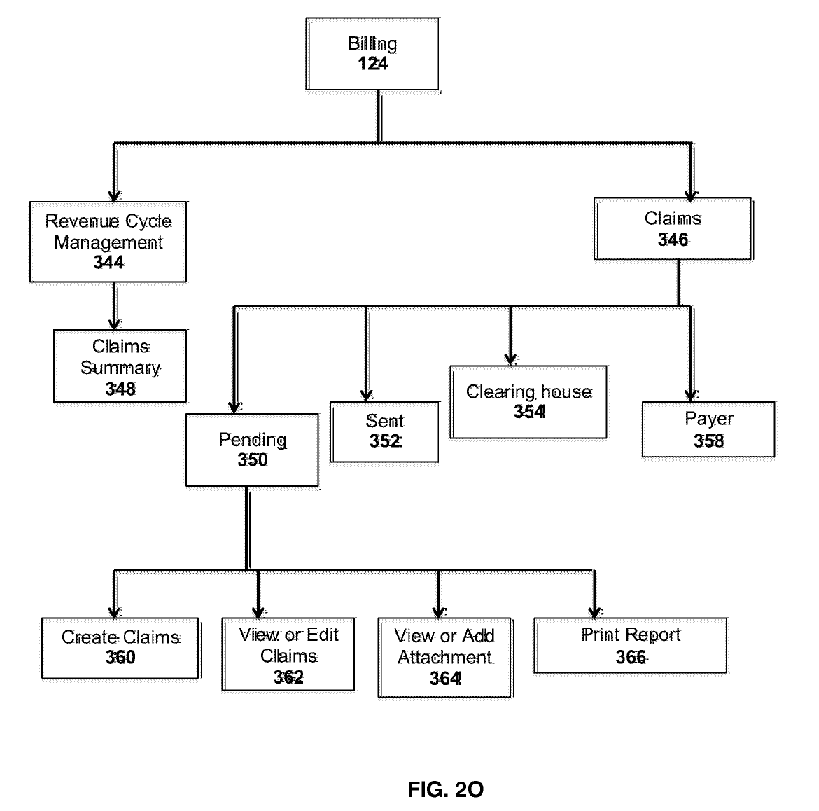

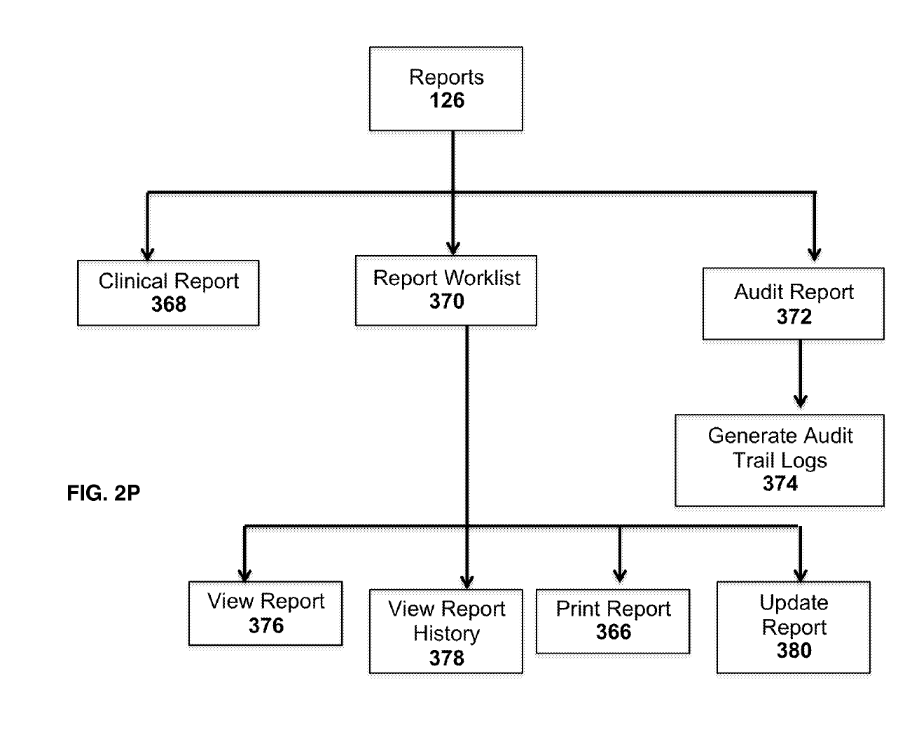

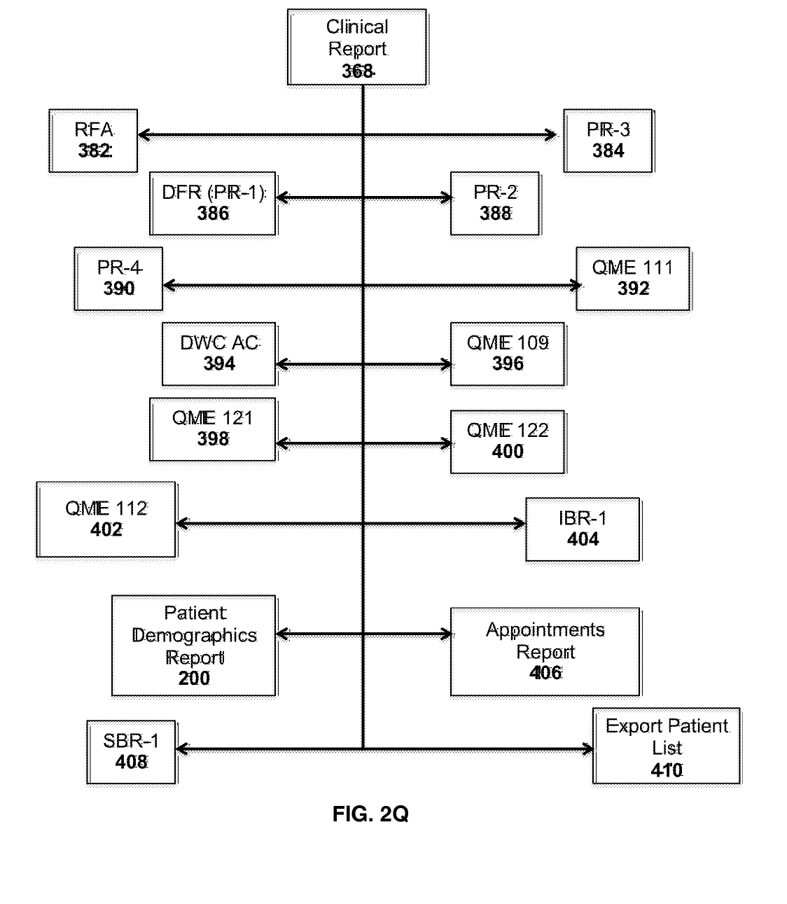

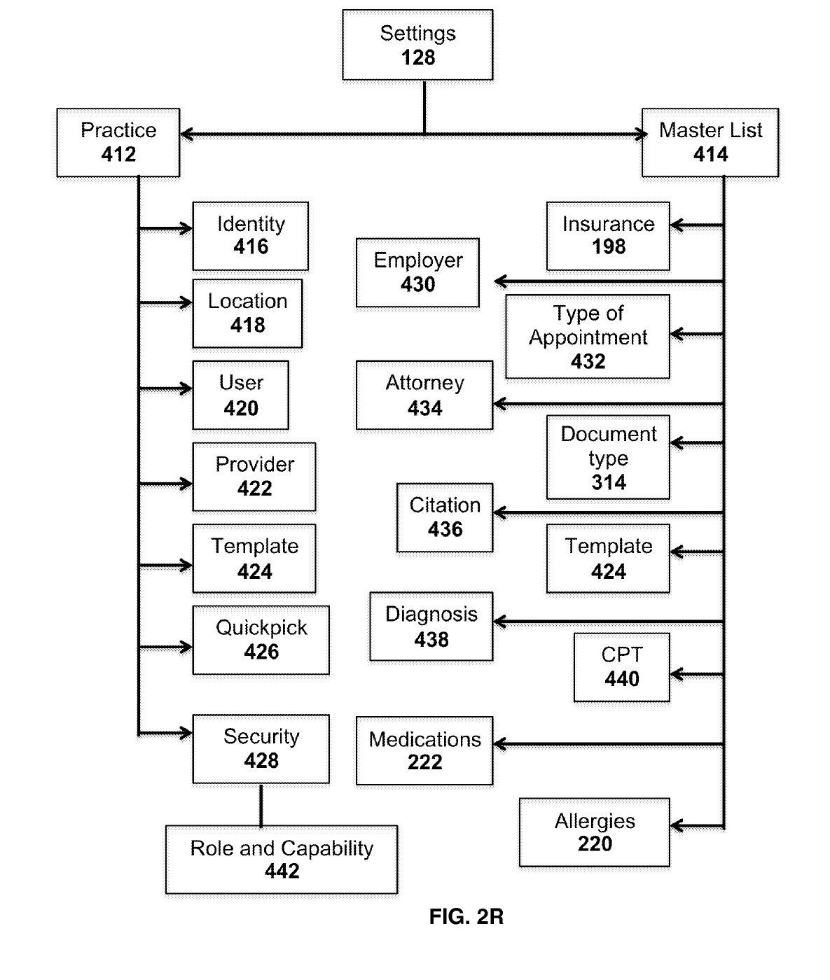

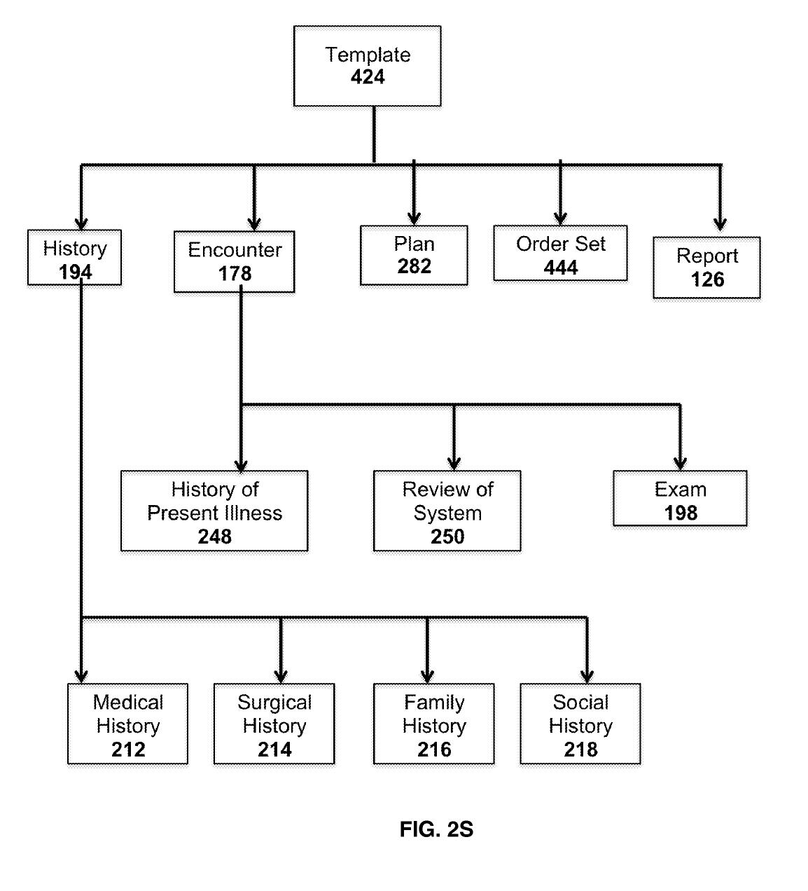

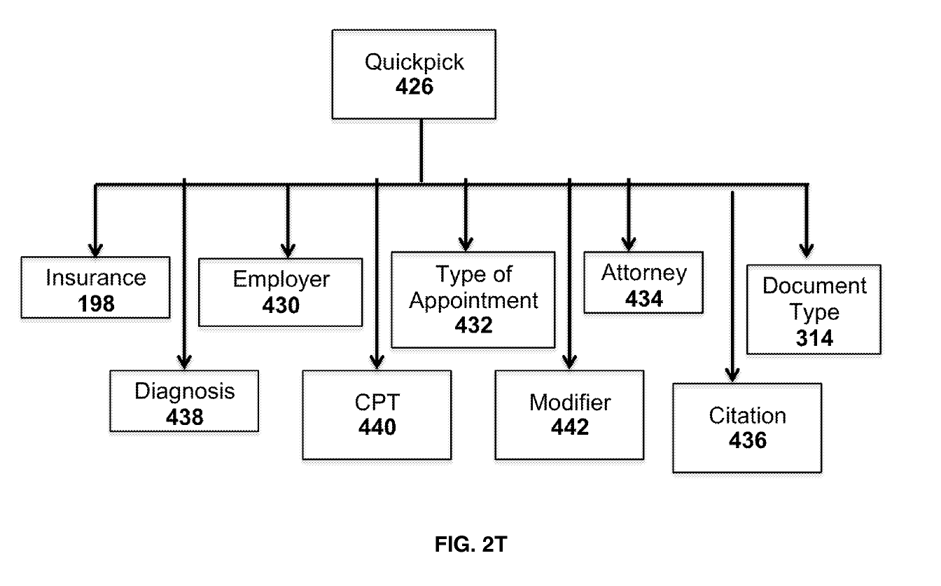

FIGS. 2A-2T are block diagrams of an exemplary Electronic Health Record (EHR) 110 of present invention having new portals for employers and insurance agencies. The EHR system of this invention is customizable where the employer and insurance agency can access the medical records of the employee (patient) to determine the status of the treatment. Detailed description of the various modules, features and functions of the Electronic Health Record is outlined below. The novel feature of the present invention is an EHR system with ability to enable insurance companies, employers and attorneys to access the medical records with restrictions to comply with HIPPA regulations.

### FIG. 2A: Electronic Health Record-User Dashboard, 112

In FIG. 2A users are directed to the respective Home dashboard when the user logs in to the Electronic Health Record (eData Clinical, eDC v1.9, 112). The Home dashboard comprises discrete components that display summary information and allow actions that are relevant to the user's capabilities and responsibilities. For example, the dashboard components are a summary view of a Scheduler 116 for scheduled appointments, Charts 118, Message Inbox 120, assigned Documents 122, Billing 124, all Reports 126 status notifications and settings 128. The user can also return Home at 114.

### FIG. 2B: Home 114

Generally, with continued reference to FIG. 2A, FIG. 2B depicts the features of the Home 114 module. For example, as described in more detail below, a user has access to My Appointments 130, Facility Appointments 132, My Documents 134, Facility Documents 136, Messages 138, Alerts 140, Change Password 142, Switch User 144, and Change Practice location 146.

### My Appointments 130

My Appointments feature 130 enables the user to access all scheduled appointments assigned to them by choosing their desired date range to display. The user can see the time of the appointment, the name of the patient, and the type of appointment. Search functionality is also available if user wishes to look for a specific appointment, where the user will have an option to enter the patient's name, the type of appointment, the room of the patient and the status.

If the appointment schedule is within the day, My Appointments feature display the following options: Scheduled, Arrived, No Show and Cancelled. If the appointment schedule has already passed, the options available are: Scheduled, No Show and Cancelled. If the Appointment Schedule is still in the future (next day onwards), the options available are: Scheduled and Cancelled. Additional features are available where the user can see if an appointment needs an interpreter and identifying what language is required for the appointment.

### Facility Appointments 132/Facility Documents 136

Facility Appointments 132 feature enables the user to see all scheduled appointments within the practice location of an organization and within the date range by selecting the provider's name. The user can look for an appointment within the location by providing the patient's name, the type of appointment, the room of the patient and the status of all scheduled appointment of the selected location using the search function. Other functions available in Facility Appointments 132 are similar to the functions available in ‘My Appointments’ described supra. As such, the user may access and view all relevant documents associated with the facility with the Facility Documents 136 feature.

### My Documents 134

My Documents feature 134 enables the user to see their documents that need reviewing, signing and/or uploading. Clicking the “View or Route” icon under Actions column within the My Documents feature will redirect the page and enables the user to route documents under the Documents module. Clicking the Title of the document enables the user to preview the document in a pop up window.

In the Scan and Upload function of My Documents, the user can upload a document from a scanner. The user can scan and preview the documents before uploading and define the Document Category and Document Type, and indicate the status of the document as “For Review” “For Signing”. If the document is reviewed and signed, the system enables the user to indicate that. The user can indicate if the uploaded document is for a particular patient or associated to a patient's encounter.

In the Mailroom function of My Documents, the user can see their and other user documents that need to be reviewed, signed, uploaded, and assigned. Clicking the “View or Route” icon under Actions column will redirect the page and enables the user to route documents under Documents module. Clicking the Title of the document enables the user to preview the document in a pop up window.

### Messages 138

The Messages 138 module enables the user to see all messages received on current practice location. Features such as reply, reply all, forward, and archive are available from the Messages module. The user can view shared patient profile and other shared documents and do quick review or editing. The user can also review and edit shared CMS/bills.

### Alerts 140

The Alert feature 140 comprises several novel aspects of the electronic health record of present invention. Alerts feature enables the users to view various reports such as the pending clinical reports that require submission/review, proof of service to review/print, bills that are pending electronic submission, and RFA status, for example, RFA's awaiting issue, RFA's awaiting approval. The Alerts feature further display specific alert for Workers' compensation, such as California Worker's Compensation, where the user can review the Workers' compensation status, depending on the role and capabilities of the user defined in the Settings module.

### Change Password 142

The Change Password 142 feature is well-known and standard and enables a user to change their password as desired.

### Switch User 144

The Switch User 144 feature enables a different user to access the system, as is standard and known in the art.

### Change Practice Location 146

With the Change Practice Location 146 feature the users can change the current practice location to any other shared location if the organization has multiple practice locations.

### FIG. 2C: Scheduler 116

With continued reference to FIG. 2A, the Scheduler 116 module enables the user to schedule an appointment and see other scheduled appointments. Scheduler module enables the user to add Workers' Compensation, HMO, Medical, Medicare and PPO for physicians as Primary Treating Physician (PTP), Secondary Treating Physician (STP), Qualified Medical Evaluator (QME) and Agreed Medical Evaluator (AME) under all shared facilities within this practice. Representative features available in the Scheduler module are Practice Location Calendar 148, Schedule Appointment 150, for example, for a New Patient 158, Traditional 160 or Workers' Compensation 162, Cancel Appointment 152, Reschedule Appointment 154, and Print Scheduler Data 156.

### Practice Location Calendar 148

The Practice Location Calendar 148 feature of Scheduler module enables the users to browse dates to check the scheduled appointments by clicking the desired date. The dates may be viewed from the three calendars from current month up to next two month for ease of use.

### Schedule Appointment 150

The Scheduler Appointment 150 feature provides a preview function, as a Scheduler Appointment List, to view the timeslots in per Providers, by week and by month. The user can upload documents from a Twain compliant locally attached Scanner or local drives to be associated with this encounter. The Schedule Appointment feature enables users to add an appointment for the selected timeslot. It provides a function that fills automatically the “Reason for the Visit/Chief Complaint” under Subjective if the user fills the reason for the visit field. Additional features include a Patient Registration function where the users can add a New Patient 158 or walk-in patient or the appointment is Traditional 160, i.e., HMO, Medical, Medicare, or a PPO. A further aspect of the Schedule Appointment feature is that it enables the users to schedule appointments having one or multiple workers' Compensation Cases 162 for the patient.

### Cancel Appointment 152

The Cancel Appointment 152 feature enables users, e.g. healthcare providers, patient, and Attorney, to cancel scheduled appointments in the Cancel Appointment feature.

### Reschedule Appointment 154

The Reschedule Appointment 154 feature enables the users, e.g. healthcare providers, patient, and Attorney, to reschedule their appointments by choosing a new date and time for the new appointment.

### Print Scheduler Data 156

The Print Scheduler Data 156 feature enables a user to print a schedule detailing selected information at selected times. In non-limiting examples, the schedule can be printed for providers, can be printed weekly by month and/or schedules for appointments requiring an interpreter can be printed.

### FIG. 2D: Charts 118

With continued reference to FIG. 2A, the Charts 118 module enables users to register new patient and/or preview patient's charts along with the medical records. Generally, in an overview of the Charts page, the users can access the Patient List 164, track and keep a record of the patient's Encounters 166 from a patient's checking in until the patient's checking out with a real-time tracking of the patient and add Supplemental 168 data for the patient to the charts.

### Patient List 164

### New Patient (Patient Registration) 158

The New patient/Patient Registration 158 feature of the Patient List 164 enables the users to add new patient's charts that include information such as basic information, patient's address, contact details, the demographics of the patient, and employment details. The users can also upload all patients' medical records.

### Merge Duplicate Patient 170

The Merge Duplicate Patient 170 feature enables the users to merge patients' duplicate charts for record maintenance.

### Patient Charts 172

The Patient Charts 172 feature is a record of all the charted information associated with a patient (see FIG. 2E).

### Encounters 166

The Encounters 166 feature of the Charts module displays all information about the patient's encounter and generally comprises an Appointment Tracker 174, patient Check-In 176, the particular Encounter 178 including Intake 186, the Exam 188, patient Check-Out 180, and user Sign-Off 190.

### Supplemental 168

The Supplemental 168 feature enables a user to access a Supplemental List 182 and add to or Create Supplemental 184 information on a patient's chart.

### FIG. 2E: Patient Charts 172

The Patient Charts 172 feature of the Charts module contains information about the Patient 192 and about the patient's Health History 194.

### Patient Dashboard 196

The Patient Dashboard 196 enables the users to see the summary of patient's outstanding payments, patient information, scheduled appointments, encounters, documents, messages and reports status. For example, the Patient Dashboard comprises, but is not limited to:

### Patient Information

The Patient information feature displays patient's contact information, marital status, social security number and current employment.

### Patient Privacy

The Patient Privacy feature enables the users to update the patient's Privacy Notice, Release of Billing Information, Assignment of Benefits, and The California Immunization Registry (CAIR) Consent and Medical History Authority.

### Document

The Document feature displays all uploaded documents from Radiology type document, to Path&Labs, Medicine, Therapy, Billing, Non-medical Records and Other kind of Documents.

### Insurance 198

The Insurance 198 feature enables the users to add insurance policy, case policy, payment plan and prepayment plan for the patient that can be used for scheduling an appointment.

### Demographics 200

The Demographics feature provides a function that enables the users to change or update any patient's information such as Basic Information Section (patient's name, date of birth, social security number and gender); Patient's Address Section (physical and mailing address); Contact Details Section (patient's home phone, work phone, mobile phone, Email address, and contact preference); Demographics Section (patient's language, race, ethnicity, marital status, eyes color, hair color, blood type, date of death and if the patient is a homebound).

### Medical Providers Section

This feature provides a function that adds a physician if the patient has an attending physician, consultant physician, primary care physician and resident physician.

### Practice Locations Sections

This feature enables the users to share the patient's information and medical records to other Practice Locations within the same practice.

### Patient Privacy Section

This feature enables the users to upload signed copies of the patient's privacy with privacy notice, release of billing information, assignment of benefits, CAIR consent and medical history authority.

### Patient Billing Number Section

This feature enables the users to add the patient number in case the patient has different number in billing and in the patient number.

### Referral Section

This feature enables the users to add a referral such as Attorney, Doctor, Insurance Company and Provider Website.

### Family Members Information

This feature enables the users to add a Guardian, Next of Kin, Emergency Contact, and Guarantor information.

### Laboratory 202

In the Laboratory 202 feature, the users can add and see laboratory results of the patient.

### Current Employment 204

The Current Employment 204 feature enables the users to add or update the patient's employment information.

### Pharmacy 206

In the Pharmacy 206 feature, the users can add a pharmacy provider of the patient.

### Licenses and Permits 208

The Licenses and Permits 208 feature enables the users to add patient's licenses of issuing authority of automobile, railway, maritime, highway, hazmat, roadway and aviation. Further, the user can upload documents from Twain compliant locally attached Scanner or local drivers to be associated with the new patient.

### Worker's Compensation 210

The Worker's compensation feature 210 enables a function where the user can add Workers' compensation cases of the patient and review the summary of the Workers' Compensation Case of the patient.

### Medical History 212

The Medical History 212 feature enables the users to add a patient's medical history.

### Surgical History 214

The Surgical History 214 feature enables users to add a patient's surgical history procedures.

### Family History 216

The Family History 216 feature enables the users to add patient's family history background.

### Social History 218

The Social History 218 feature enables the users to add a patient's social history.

### Allergy History 220

The Allergy History 220 feature enables the users to add allergies of the patient.

### Medications 222

The Medications 222 feature enables the users to add all medication taken by the patient. This feature provides an advanced search function to simplify the browsing of the medication where the medication can be browsed by Generic, Brand or Substance name.

### Problems List 224

The Problems 224 feature enables the users to add a history of the problems encountered by the patient.

### FIG. 2F: Appointment Tracker 174

With continued reference to FIG. 2D, the Appoint Tracker 174 feature enables a user to keep track of patients with scheduled 226 appointments. A user can also utilize a filter in searching appointments at 228.

### FIG. 2G: Check-in 176

With continued reference to FIG. 2D, the Check-in 176 feature enables a user to Verify Patient Information 230 and Confirm a Check-in 232. After confirmation, the Intake Form can be printed at 234 and a Room Selection 236 made for the appointment.

### FIG. 2H: Intake 186

With continued reference to FIGS. 2D-2E, the Intake 186 feature of the Charts module is linked to the Medical History 212, Surgical History 214, Family History 216, Allergies 220 information, Medication History 222, and Problem List 224 described in FIG. 2E. In addition the user has access to the following:

### Case Information 238

The Case Information feature 238 enables the users to update and verify all information from the worker's compensation of the patient. Case information includes specific information about the injury such as the date of injury, the Workers' Compensation claim number, and the claims status. Further, the Case Information feature provides information on the parts of the body that were injured, the status of the insurance company's acceptance of responsibility, law firms/Attorney involved in either defending or representing the injured worker.

### Mechanism of Injury 240

The Mechanism of Injury feature 240 enables users to narrate how the incident happens to the patient.

### Link Documents 242

The Link Documents 242 feature enables a function where the user can see all uploaded documents related to the patient, a specific WCAB case or a specific Encounter.

### Subjective 244

The Subjective 244 feature enables a user to enter information specific for a current appointment provided by the patient as follows:

### Reason for the Visit/Chief Complaint 246

The Reason for the Visit/Chief Complaint 246 feature enables the users to add or update the brief statement of the complaint or incident that prompted medical consultation. Further, a function is provided in this feature to retrieve the information from the scheduling module about the reasons for the patient's visit. Additionally, the users can copy the chief complaint if the patient's complaints are identical or similar to previous encounter.

### History of Present Illness 248

The History of Present Illness 248 feature enables the users to add a history of present illness of the patient by using the pre-made template in settings module. The users can add an HPI of the patient obtained during the interview with the patient of the onset, duration, character of the present illness. Additionally, this feature provides a function which enables the users to copy the chief complaint if the patient's HPI are identical or similar to previous encounters.

Done with Intake

With continued reference to FIG. 2G, the Intake 186 feature enables a function that allows the users to proceed to the next step of the encounter. The users can indicate the room that the patient will be and/or change the attending physician for the current patient. The users can print the intake form 234 having all the information encoded by the user filled out all the fields.

### FIG. 2I: Exam 188

With continued reference to FIGS. 2D and 2H, the Exam 188 feature of the Charts module is linked to the Subjective 244 feature in FIG. 2H including the History of Present Illness 248 information plus enabling a user to review the system 250 and further comprises the following:

### Review of System 250

The Review of System (ROS) 250 feature enables the users to add a review of system of the patient by using the pre-made template in settings module. The users can add a ROS of the patient for eliciting a medical history from a patient. The Review of System feature further provides a function that enables users to copy the review system if the patient's ROS are identical or similar to previous encounter.

### Objective 252

The Objective 252 feature enables a user to enter or retrieve objective information such as Vital signs 254, Exam 256, Diagnostic Studies 258, and Laboratory Report 260 acquired during the patient's appointment as follows:

### Vital Signs 254

The Vital signs 254 feature enables the users to add clinical measurements of the patient, specifically pulse rates, temperature, respiration rate, and blood pressures. A function is provided to the user to obtain the body mass index (BMI) where the user upon providing the height and weight of the patient, the function computes the BMI.

### Exam 256

The Exam 256 feature enables the users to add clinical measurements of the patient specifically pulse rates, temperature, respiration rate and blood pressures. The users can add medical information of the patient gathered through investigations of the body of the patient for signs of injuries, fractures, diseases and other kinds of sickness. Also, it enables the users the ability to copy the exam if the patient's exam is identical or similar to previous encounter.

### Diagnostics Studies 258

The Diagnostics Studies feature enables the users to narrate all kinds of diagnostic test or medical test performed to aid in the diagnosis or diseases found during patient's encounter. The users can copy the diagnostics studies if the patient's diagnostics are identical or similar to previous encounter.

### Laboratory Report 260

The Laboratory Report 260 feature enables the users to narrate all of the laboratory results from the patient's laboratory examinations. The users can copy the laboratory report if the patient's laboratory results are identical or similar to previous encounter.

### Medical Record Review 278

The Medical Record Review feature 278 enables the users to narrate all of the patient's medical information such as medical history, care or treatments received, test results, diagnosis and medications taken. The users can copy the medical record if the patient's medical information is identical or similar to previous encounter.

### Assessment 280

The Assessment 280 feature enables a function that allows the users to add patient's abilities determined during encounter, patient needs in assistance to the diagnosis of the patient using the ICD 9 and 10 included in the ICD quickpick under settings module. An advance search function is provided which enables a user to browse ICD 9 and ICD 10 codes and add the code in the quickpick without the need of going back to settings module. Several other functions are also provided such as a function to validate the diagnosis list in the assessment to avoid code duplications and a remove function to allow the users to remove the specific ICD code if the user encodes an incorrect diagnosis for the patient.

### Plan 282

With the Plan 282 feature, the user creates the plan using a decision tree to list questions and possible responses to reduce transcription or transcription errors or omissions. For example, the decision tree may comprise, but is not limited to, the following:

### DISCUSSION

This feature enables the users to add a discussion with the patient using the pre-made plan template added under settings module. The users can copy the discussion if the patient's interview with the physician is identical or similar to previous encounter.

### Treatment Recommendation

This feature enables the users to add treatment recommendation where the user can indicate the order type of the treatment. The user can set the procedure or the Current Procedural Terminology (CPT) for the specific treatment and add citation using the premade template under settings module.

### AOE/COE

This feature enables the users to narrate Workers' Compensation arising out of employment or course of employment. The users can copy the AOE/COE if the patient's interview with the physician is identical or similar to previous encounter.

### Disability Status

This feature of the present EHR system enables the user to narrate a record of any type of physical or mental impairment of the patient. The user can copy the disability status if the patient's status is identical or similar to previous encounter.

### ADL/Functional Capacity Evaluation

This feature enables the users to narrate the routine activities that patient tend to do without needing assistance. The user can copy the discussion if the patient's interview with the physician is identical or similar to previous encounter.

### Work Status

This feature comprises the following decisions about the patient:

### Remain Off Work Until

This feature enables the users to indicate the date until when the patient will remain off work.

### Return to Modified Work on

This feature enables the users to indicate the date when the patient will return to work but with modified job duties.

### Return to Full Duty

This feature enables the users to indicate the date when the patient will return to full duty without limitations or restriction with the patient's job duties.

### Work Restrictions

This feature enables the users to narrate what are the limitations that they will indicate to the patient based on the medical information of the encounter. The user can copy the work restrictions give to the patient's previous encounter.

### Impairment Rating

This feature enables the users to narrate the individual's impairment that deviates away from the patient's normal health status and functionality. The user can copy the work restrictions give to the patient's previous encounter.

### Causation

This feature enables the users to narrate the cause of the accident that happened to the patient. The user can copy the work restrictions give to the patient's previous encounter.

### Appointment

This feature enables the users to narrate the appointment of permanent disability of the patient based on patient's causation. The user can copy the work restrictions given to the patient's previous encounter.

### Future Medical Care

This feature enables the users to narrate an on-going right to medical treatment for a work related injury for the patient. The user can copy the work restrictions given to the patient's previous encounter.

### Notes

This feature enables the users to include additional notes for the patient's workers' compensation encounter. The user can copy the work restrictions given to the patient's previous encounter.

Next Visit after

This feature enables the users to set the number of day(s), week(s), or month(s) until the next visit of the patient.

### Being Referred to

This feature provides a function that enables the users to refer the patient to a different physician of the same practice.

Done with Exam

In this, a function is provided which enables the users to proceed to the next step of the encounter. Specifically, a function is provided where the users indicate the room that the patient will be next seen by a service provider (e.g. Exam Room 1 or Ultrasound Room). Also, the user can change the attending physician for the current patient to continue the encounter. The user can print the exam form having all the information encoded by the user filled out all the fields.

### FIG. 2J: Sign-Off 190

With continued reference to FIG. 2D, the Sign-Off 190 feature in the Charts module enables a user to Generate and Review Reports 262 and Upload Documents 266 and to Link the Reports to an Encounter 264 and Electronically or digitally Sign the Encounter 268, as follows:

### Generate and Review Report 262

The Generate and Review Report 262 feature enables the users to generate, preview and print reports based on patient appointment type. The generated report meets the requirements for California Workers' Compensation. A function is provided where the user is mandated to select one from Report RFA and PR check-box header. Additionally, the users can include a Proof of Service of the patient's encounter.

### Link Report to Encounter 264

In the Link Report to Encounter 264 feature the user can see and preview all reports generated for the patient's encounter.

### Upload Documents 266

The Upload Documents 266 feature enables a function that allows the users to upload a related or supporting document of the patient for medical record keeping purposes.

### Electronically Sign Encounter 268

The Electronically Sign Encounter 268 enables the provider to sign the patient's encounter electronically, which can be added, in the generated report. The users can indicate the room that the patient will be seen by a service provider or can change the attending physician of the current patient to continue encounter.

### FIG. 2K: Check-Out 180

With continued reference to FIG. 2D, the Check-Out 180 feature in the Charts module enables a user to access the Assessment(s) 280, to Create 290 and Charge 286 for an Entry, enter Orders 282, including Prescriptions 284, for the patient and Amend 288 this information as necessary, as follows:

### Assessment(s) 280

The Assessment(s) 280 feature provides a list of all diagnosis found during a patient's encounter.

### Order(s) 282

The Order(s) 282 feature enables the physician to write their medical instruction for the patient and/or recommendations electronically with the physician's signature.

### Prescription 284

The Prescription 287 feature enables the physician to write out prescriptions electronically with the physicians signature and send the same electronically to a pharmacy.

### Charge Entry 286/Create Charge Entry 290

The Charge Entry feature 286 enables a function that allows the users, for example, a care provider, to indicate the procedure, service or supply done with the patient's encounter. The user can add multiple diagnoses for the patient and provides an option to indicate if the charge entry is a billable or non-billable entry. As such, the user can create a charge via the Create Charge Entry 290 feature.

### Amend 288

The Amend 288 feature enables the users to amend any patient's encounter to make changes in order to improve accuracy of level of detail.

### FIG. 2L: Messages 138

With continued reference to FIG. 2B, the Messages 138 feature in the Home module comprises an Inbox 292, a list of Sent Items 294, Archives 296 and enables a user to Compose 298 a message, Reply 300 to a message, Forward 302 a message, and/or a message can be Moved to Archive 304 as is well-known and standard in email systems and other messaging protocols.

### FIG. 2M: Documents 122

With continued reference to FIG. 2A, the Documents 122 module enables the users to see the list of uploaded Documents 306 displaying the document title, Document Type 314, date when the documents are uploaded and the patient's name if it is linked to any patient, see a Document Summary 316 and see a list of Archived Documents 310. The module comprises an Advance Upload 308 feature. Users can see the summary of the Document Statistics 312 to see the traffic of the documents that the user uploads.

### Documents 306

The Documents 306 feature enables a user to access a list of all available documents with the following features:

### Document Type 314

The Document Type 314 feature enables the users to see the list of available document types where by clicking each type displays a list of uploaded documents in the selected document type.

### Document Summary 316

The Document Summary 316 feature enables the users to see summary of uploaded documents within the practice location.

### Advance Upload 308

The Advance Upload 308 feature enables an advanced upload function where users can upload various documents such as medical records, billing records, radiology etc.

### Document Archive 310

The Document Archive 310 feature provides a list of all preserved documents after the users archived the uploaded, signed and reviewed documents.

### Document Statistics 312

The Document Statistics 312 feature enables a statistical view of all uploaded documents by the users.

### FIG. 2N: Document Type 314

With continued reference to FIGS. 2B, 2L and 2M, the Document Type 314 category comprises Chart Notes 318, EHS 320, Authorizations 322, Treatments/Procedures 324, Outside Records 326, Billing 124, Messages 138, Alerts 140, and Other Documents 328. Non-limiting examples of documents comprising Treatments/Procedure 324 encompass Prescriptions 284, Therapy & Acupuncture, Pathology and Labs 332, Radiology 334, and Medicine 336 as are standard in the medical arts. Other Documents 328 can encompass, but are not limited to, Registration 338 information, Correspondence 340 and Others 342.

### FIG. 2O: Billing 124

With continued reference to FIG. 2A, the Billing 124 module enables the users to access their Revenue Cycle Management 344 summary for revenue tracking of the collected and uncollected claims 346. In this module, the users can access and view a list of claims submitted electronically to insurance companies in order to receive payment for services rendered by a healthcare provider, as per the following features:

### Revenue Cycle Management 344

The Revenue Cycle Management 344 feature enables the users to access and view a summary of paid claims, uncollected claims and pending claims for all practice locations that are connected to the main practice. As such the feature provides a Claims Summary 348.

### Claims 346

The claims 346 feature provides a clear view of the claim cycle allowing the creation of medical bill to send out to payer companies in order to collect the revenue generated from covered patients. The feature comprises Pending 350 claims, Sent 352 claims, a Clearinghouse 354 for claims, and Payer 358 information. Particularly, for Pending 350 claims, a user can Create claims 360, View or Edit claims 362, View or Add Attachments 364 to the claims, and/or Print a Report 366, as is known and standard in Worker's Compensation Claims systems.

### FIG. 2P: Reports 126

With continued reference to FIG. 2A, the Reports 126 module enables the users to generate, track and audit reports. Generally the module comprises a Clinical Report 368 feature, a Report Worklist 370 feature and an Audit Report 372 feature as follows:

### Clinical Report 368

In the Clinical Report 368 feature the users can generate reports of the Sign-Off without the need of users going back to encounter.

### Report Worklist 370

The Report Worklist 370 feature enables a user to View Report 376, View Report History 378, Print Report 366, and Update Report 380. The feature enables a user to update the status of the generated reports during patient encounter where they can send, approve or deny the report.

### Audit Report 372

The Audit Report 372 feature enables the user to trace all user activities within the system filtered by User, Patient, Provider, Date period or activity type and to generate an audit report. The feature also enables a user to view all reports generated during the patient encounter and update the status thereof.

### FIG. 2Q: Clinical Report 368

With continued reference to FIG. 2P, the Clinical Report 368 feature enables a user to generate a plurality of reports. In non-limiting examples and as known in the art, examples of reports from the states Division of Worker's Compensation may be or comprise a Request for Authorization for Medical Treatment (RFA) 382, a Primary Treating Physician's Permanent and Stationary Report of 1997 (PR-3) 384, a Doctor's First Report of Occupational Injury or Illness (DFR/PR-1) 386, a Primary Treating Physician's Progress Report PR-2388, a Primary Treating Physician's Permanent and Stationary Report of 1997 (PR-4) 390, a Qualified Medical Evaluator's Findings Summary Form-Unrepresented cases (QME 111) 392, a DWC AC 394, a Qualified Medical Evaluator's Notice of Unavailability (QME 109) 396, a Declaration regarding Protection of Mental Health Record (QME 121) 398, a Qualified Medical Evaluator's Declaration of Service of Medical-Legal Report (QME 122) 400, a Qualified Medical Evaluator's Report Time Frame Extension Request (QME 112) 402, an Independent Bill Review (IBR-1) 404, a Patient Demographics Report 200, an Appointments Report 406, a Provider's Request for Second Bill Review (SBR-1) 408, and an Export Patient List 410 report. Select examples follow:

### Request for Authorization for Medical Treatment (RFA) 382

The Request for Authorization for Medical Treatment Form 382 (DWC Form RFA) is required for the employee's treating physician to initiate the utilization review process required by Labor Code section 4610. Other forms that would be attached are, a Doctor's First Report of Occupational Injury or Illness, a DLSR-5021 form, a Treating Physician's Progress Report, a DWC Form PR-2, or equivalent narrative report substantiating the requested treatment. This report is available if the provider is a Primary Treating Physician (PTP), the appointment is a Follow-up or a new patient visit.

### Request for Independent Bill Review (IBR 1) 404

If the dispute between a medical provider and a claims administrator regarding a bill for medical treatment services or a bill for medical medical-legal expenses is the amount of payment and the second bill review did not resolve the dispute, the provide may request independent bill review (IBR) 404 from a conflict-free payment and billing expert. The Division of Workers' Compensation (DWC) has contracted with an independent bill review organization (IBRO) to provide an efficient means of resolving worker's compensation billing disputers. A request for IBR must be made within thirty days from the date of service of the final determination made by the claims administrator on the request for second bill review. Failure to request IBR within 30 days and the only dispute remaining is the amount of payment, the bill will be considered satisfied and neither the claims administrator not the employee shall be liable for any further payment.

### Provider's Request for Second Bill Review (SBR 2) 408

The Provider's Request for Second Bill Review (DWC Form SBR-1) 408 is used to initiate the second bill review process as required by Labor Code sections 4603.2(e), for medical treatment services and goods and Labor Code section 4622, for medical legal services, to dispute the amount of payment. The Division of Workers' Compensation's (DWC) regulation outlining the process can be found at California Code of Regulations, title 8 (8 C.C.R), section 9792.5.5. Under this process, a medical provider who disputes the amount paid by a claims administrator on either a bill for medical treatment services or goods, or a bill for medical-legal expenses, must request a second review of the bill from the claims administrator. The second bill review process must be completed before a provider can seek independent bill review of a billing dispute.

A request for a second bill review must be made within 90 days of service of the explanation of review that explained why the payment sought in the initial bill was reduced or denied. If an issue that would preclude the user right to receive compensation for the submitted bill is under consideration by the Workers' Compensation Appeal Board (WCAB), the user will have 90 days from the date of the service of the WCAB order that resolves the issue to request the second bill review. If the only dispute is the amount of payment and the user does not timely request a second bill review, the bill will be considered satisfied and neither the claims administrator not the employee shall be liable to the user for any further payment.

### FIG. 2R: Settings 128

With continued reference to FIGS. 2A, 2E and 2N, the Settings 128 module enables the users to define the relevant information to comply with the Practice's 412 internal business processes. Users need to set up and define each module prior to implementation to the end users. Practice modules comprise Identity 416, Location 418, User 420, Provider 422, Template 424, Quickpick 426, and Security 428. The Settings module also comprises maintaining the Master List 414. Generally, he Master List category is where the users see lists of globally unique data maintained by the users having an access role of System Administration in the administration side of the system. The users can see information regarding insurance companies, employer, law office/Attorney, documents type, and the medical, surgical, family and social history available for the practice. The Master List encompasses, but is not limited to, Insurance 198, Employer 430, Type of Appointment 432, Attorney 434, Document type 314, Citation 436, Template 424, Diagnosis 438, CPT 440, Medications 222, and Allergies 220. The system can be customized by practice, by specialty, by provider which are well known settings and standard across EHR systems.

### Identity 416

The settings for Identity 416 comprise basic information of the organization, for example, identity and location of the organization may be provided here. The users can include organization name, contact person, the physical and mailing addresses of the practices.

### Location 418

The settings for Location 418 in the Practice category enables a user to set up the practice location details and specialization of the practice location. If the organization has a practice in more than one location, the various practice locations may be included. In addition, the users can setup the practice's Time Zone, the Days of Operation and the Business hours.

### User 420

The settings for User 420 in the Practice category include existing or new users for the practice and can identify the credentials of the new users, such as Ancillary Staff, Licensed Nurse, Mid-Level, Provider.

### Provider 422

The settings for Provider 422 in the Practice category include existing or new medical care providers for the patients.

### Template 424

The settings for the Template feature in both the Practice and Master List categories enables a user to create a new document with the Template as a starting point as is known in the art.

### Quickpick 426

The Quickpick 426 feature in the Practice category is utilized by the users in each Practice Location to speed up the browsing of data and the Security that handles the authorization of each module that needs to be defined prior to using the system.

### Security 428

The Security 428 feature in the Practice category is where the user ensures the authorization of the end users to various modules. The user can identify features and capabilities of each user, employer, Attorney, or the adjuster and their access to various modules via the Role and Capability 442 feature.

### Insurance 198

The Insurance 198 feature in the Master List category enables the users to see the list of Practice's active payer companies. The user can add payer in the quickpick list for the Practice and will be searchable in other modules such as Workers' Compensation Case, Billing and Charts.

### Employer 430

The Employer 430 feature in the Master List category enables the users to see the list of both active and inactive Employers. The user can add one or more employers in the Quickpick list for the Practice and it is searchable in other modules such as Workers' Compensation Case, Billing and Charts.

### Law Office/Attorney 434

The Law Office/Attorney 434 feature in the Master List category enables the users to see the list of both active and inactive Law Offices/Attorneys. The user can add one or more Law Offices and Attorneys in the Quickpick list for the Practice and it is searchable in other modules such as Workers' Compensation Case, Billing and Charts.

### Document Type 314

The Document Type 314 feature in the Master List category enables the users to see the list of all document types as described in FIG. 2N. The user can add one or more types of documents in the Quickpick list for the Practice and it is searchable in other modules such as Documents, Worker's Compensation, Billing, Charts, etc.

### Citation 436

The Citation 436 feature in the Master List category is a novel feature and enables the user to see all citations added to patient records concerning coverage of treatment or therapies recommended by medical care providers. The user can add one or more citations as new or additional courses of therapy, etc. are recommended and it is searchable in other modules such as CPT, Diagnosis, Charts, and Billing, etc.

### Diagnosis 438

The Diagnosis 438 feature of the Master List category enables the users to see the list of all diagnoses. The user can add one or more diagnoses in the Quickpick list for the Practice which is searchable in other modules such as Charts, Billing, Documents, Billing, etc.

### Current Procedural Terminology 440

The Current Procedural Terminology (CPT®, owned by the American Medical Association) 440 feature in the Master List category is a standard list of codes for widely accepted medical nomenclature used to report medical procedures and services under public and private health insurance programs. The CPT codes generally are embedded with other features such as a treatment or plan of therapy, diagnosis, billing, etc. Frequently used CPT codes can be included on a Quickpick list by the user.

### FIG. 2S: Template 424

With continued reference to FIGS. 2A, 2D, 2E, 2I, and 2R, the Template 424 feature in the Settings module comprises templates for creating a document, report, list, or archive for, but not limited to, History 194, Encounter 178, Plan 282, Order Set 444, and Report 126. The History feature encompasses Medical History 212, Surgical History 214, Family History 216 and Social History 218. The Encounter feature encompasses History of Present Illness 248, Review of System 250 and Exam 198. The creation and use of templates is well-known and standard in the art.

### FIG. 2T: Quickpick 426

With continued reference to FIG. 2R, the Quickpick feature 426 in the Practice Category of the Settings module enables a user to create and access lists of favorite or frequently accessed data quickly to speed up search, browsing and security functions in the Practice system. Quickpick lists can be created for Insurance 198, Diagnosis 438, Employer 430, CPT 440, Type of Appointment 432, Role and Capability for security purposes 442 or other Modifiers, Attorney/Law Offices 434, Citation 436, and Document Type 314.

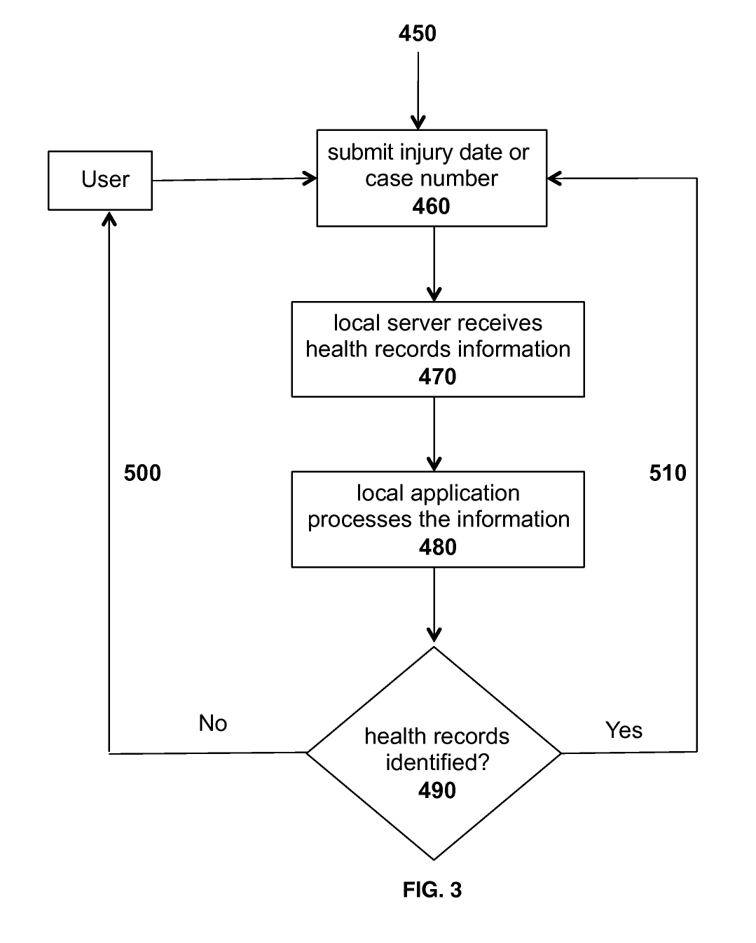

FIG. 3 illustrates the method to request Electronic Health Records of a patient for worker's compensation claims, the user submits the injury date of the employee or the case number associated with the injury date data at terminal 460. The local server receives the medical records information at 470 from the system terminal and the local application processes the order at 480. If the process is successful and the health records are identified at 490, the information is sent to the user and information is displayed at the system terminal 500. If the health records are not found, the user is informed at 510 whereupon the user may make another inquiry at 460 or exit the system.

What is claimed is:

1. A system for creating a healthcare record for one or more medical event(s) of a patient comprising:
a computer having at least a processor, a memory and a display coupled to the processor and at least one network connection; and
a user interactive tool coupled to the computer comprising:
a plurality of modules configured to process worker's compensation information; and
a plurality of databases related to healthcare information of the patient accessible by the modules.

2. The system of claim 1, wherein the user interactive tool is further configured to update the healthcare record of the patient.

3. The system of claim 1, wherein the user interactive tool modules are configured to:
a) receive information related to one or more medical event(s) of interest of said patient;
b) store and categorize the medical event(s) of the patient and information related thereto in a raw information library comprising the databases; and
c) create the healthcare record comprising the healthcare information of said patient.

4. The system of claim 3, wherein the user interactive tool modules are further configured to update the healthcare record of the patient via iteration of a) to c).

5. The system of claim 3, wherein the user interactive tool modules are further configured to:
d) receive as input a query about user-selected medical events;
e) search one or more databases about the user-selected medical event(s) information;
f) retrieve the user-selected medical event(s) information from the databases;
g) update the retrieved user-selected medical event(s) in the healthcare record of said patient; and
h) transmit the modified healthcare record to the user.

6. The system of claim 5, wherein the user interactive tool modules are further configured to reiterate steps d) to h) upon input of an additional query.

7. The system of claim 1, wherein the healthcare information of the patient comprises injury date data.

8. The system of claim 7, wherein the healthcare information comprises medical event(s) categorized by the injury date data of the patient.

9. The system of claim 1, wherein the healthcare information comprises disability status of the patient, treatment data of said patient's condition, injury or disease, or worker's compensation transactions or a combination thereof.

10. The system of claim 1, wherein the healthcare information of the patient comprises a case number assigned to the injury date data of the patient.

11. The system of claim 1, wherein said user is an employer, an attorney, a physician or other medical provider, or an insurance company.

12. A user-customized method for obtaining a healthcare record of one or more medical event(s) of a patient, comprising the steps of:
accessing the user interactive tool comprising the system of claim 1;
user-inputting a query about user-selected medical events of said patient;
searching the databases for the user-selected medical events via the one or more modules comprising the user interactive tool;
retrieving a healthcare record comprising information about the user-selected medical events from the databases; and
transmitting the healthcare record to the user.

13. The user-customized method of claim 12, further comprising updating the healthcare record via the modules.

14. The user-customized method of claim 12, wherein the healthcare record comprises information on worker's compensation claims of the patient.

15. The user-customized method of claim 14, further comprising assigning a case number to injury date data in the worker's compensation claim.

16. The user-customized method of claim 12, wherein the healthcare record comprises treatment data of said patient's condition, injury or disease or disability status of said patient or a combination thereof.

17. A non-transitory machine-readable storage medium comprising processor executable instructions for performing the method of claim 12.

18. A method for providing patient information related to a worker's compensation transaction to a user, comprising the steps of:
a) receiving a user inquiry as input into a healthcare computing system comprising at least one computer having a memory, a processor and at least one network connection;
b) processing the inquiry with an application or components thereof distributed and deployed to a local server on the healthcare computing system; and
c) displaying a response to the inquiry to the user.

19. The method of claim 18, wherein the worker's compensation transaction comprises injury date data, treatment data and disability status data of said patient.

20. A non-transitory storage medium having tangibly stored thereon instructions that, when executed by at least one processor of an electronic device, cause the electronic device to perform the method of claim 18.
